(19) United States
(12) Patent Application Publication
(10) Pub. No.: US 2026/0365910 A1
(43) Pub. Date: Nov. 19, 2026

(54) METHOD FOR IN-SITU SAND CONSOLIDATION

(71) Applicant: SAUDI ARABIAN OIL COMPANY, DHAHRAN (SA)

(72) Inventors: Mohammed Ibrahim Alabdrabalnabi, Al Qatif (SA); Mohammed Bataweel, Dhahran (SA); Ayman Almohsin, Dhahran (SA); Ahmad Busaleh, Saihat (SA); Tariq Abdulsattar Almubarak, Dhahran (SA)

(73) Assignee: SAUDI ARABIAN OIL COMPANY, Dhahran (SA)

(21) Appl. No.: 19/208,952

(22) Filed: May 15, 2025

(51) Int. Cl. C09K 8/57; E21B 43/02

(52) U.S. Cl. CPC C09K 8/572; E21B 43/025

(57) ABSTRACT

A method for in-situ sand consolidation, the method including introducing sodium metasilicate into a subterranean formation within a wellbore and injecting supercritical carbon dioxide into the subterranean formation thereby forming a silica hydrogel and consolidating sand grains with the silica hydrogel, wherein a temperature of the subterranean formation ranges from 70 to 300 °F. A sand consolidation composition including a consolidated sand formation and a silica hydrogel, wherein the silica hydrogel is formed by: introducing sodium metasilicate into an unconsolidated sand formation within a wellbore; and injecting supercritical carbon dioxide into the unconsolidated sand formation, wherein a temperature of the subterranean formation ranges from 70 to 300 °F.

### BACKGROUND

“Sanding” in oil production and water injection wells refers to formation sand or fines that is produced with fluids, such as oil and water. Sanding may plug tubing, casing, flowlines, and surface vessels, leading to loss of well control or unwanted fluid emissions.

Sandstone formations exhibit cases of this type of sand production due to the weak bonds between the grains. Sand production would result in a variety of issues such as requiring extremely high drawdown pressures to produce the well and can cause significant erosion to the pipelines and tubulars if production is initiated.

The potential plugging and loss of permeability caused by using sand consolidation chemicals like polymers or resins. Also, the use of flammable chemicals introduces safety concerns during field operation. Current sand control options also result in a lowering of the formations permeability. Accordingly, there exists a need for consolidating sand while retaining permeability in the target zone.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for in-situ sand consolidation, the method including introducing sodium metasilicate into a subterranean formation within a wellbore and injecting supercritical carbon dioxide into the subterranean formation thereby forming a silica hydrogel and consolidating sand grains with the silica hydrogel, wherein a temperature of the subterranean formation ranges from 70 to 300 °F.

In another aspect, embodiments disclosed herein relate to a sand consolidation composition including a consolidated sand formation and a silica hydrogel, wherein the silica hydrogel is formed by introducing sodium metasilicate into an unconsolidated sand formation within a wellbore and injecting supercritical carbon dioxide into the unconsolidated sand formation, wherein a temperature of the subterranean formation ranges from 70 to 300°F.

Other aspects and advantages of the claimed subject matter will be apparent from the following description and the appended claims.

### BRIEF DESCRIPTION OF DRAWINGS

FIG. 1 is a method in accordance with one or more embodiments.

FIG. 2 shows an image of the initial loose unconsolidated sand prior to introduction of chemicals as described in Comparative and Example 1.

FIG. 3 is an Environmental Scanning Electron Microscope (ESEM) image of consolidated sand samples as described in Example 1.

FIG. 4 is another ESEM image of consolidated sand samples at a different location as described in Example 1.

FIG. 5. shows an image of consolidated silica sand as described in Example 1

FIG. 6. is an ESEM image of unconsolidated silicate sand as described in Comparative Example 1.

### DETAILED DESCRIPTION

Sanding in wells may cause productivity decline compared to wells without excessive sand production. Sanding may damage subsurface equipment through erosion or wear. Sanding may also halt production and require cleanout of wells. If a well becomes clogged with sand or collapses, production may be permanently halted from a portion of the reservoir.

In one or more embodiments of the present disclosure, a composition and method are provided to generate an environmentally friendly solution that has low impact on the permeability reduction due the nature of the operation and pumping sequence. The embodiments will permit the in-situ formation of consolidated sand while maintaining the permeability of the formation.

In one aspect, embodiments disclosed herein relate to a method for in-situ sand consolidation. The sand consolidation composition and method of one or more embodiments is based on the introduction of supercritical CO₂ in a way that creates pathways for flow in the matrix and reacts with stagnant sodium metasilicate to create the bonding material. The method therefore ensures adequate permeable pathway generation.

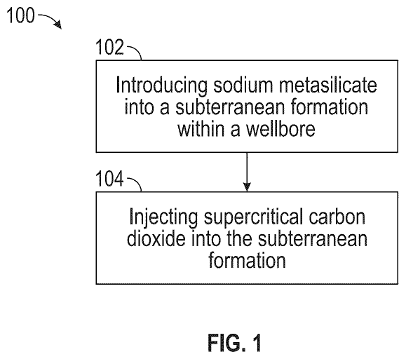

According to one or more embodiments, and as shown in FIG. 1, the method 100 comprises the steps introducing sodium metasilicate into a subterranean formation within a wellbore 102 and injecting supercritical carbon dioxide into the subterranean formation thereby forming a silica hydrogel and consolidating sand grains with the silica hydrogel 104 wherein a temperature of the subterranean formation ranges from 70 to 300 °F.

As described above, the method 100 includes introducing sodium metasilicate into a subterranean formation within a wellbore 102. The method may also include introducing an additive into the formation of the wellbore. The sodium metasilicate and the additive may be introduced to the subterranean formation separately. For instance, the sodium metasilicate and the additives may individually be stored in any suitable vessel and individually introduced to the subterranean formation. Alternatively, the sodium metasilicate and the additive may be mixed before being introduced to the subterranean formation and prior to the injection of supercritical carbon dioxide.

According to one or more embodiments, the subterranean formation may be an unconsolidated formation such as a sandstone formation. The method may also be applied to production wells. The methods described herein may also be used in a subterranean formation that includes an area of under-consolidated sand. Formations with under-consolidated sand exhibit cases of sand production due to the weak bonds between the grains, thereby forming a consolidated sand. As a result of the method described herein, a productive consolidated sand may be formed in the formation that is porous and permeable thereby solving the problem by binding the sand grains to each other resulting in a more stable and permeable formation that will not induce sand production. The method may also be used to maintain a well that has already been consolidated.

The methods disclosed herein may be applied to subterranean formations that possess a wide range of temperatures. According to one or more embodiments, the temperature of the subterranean formation may range from about 70 to 300°F, such as from a lower limit of any one of 70, 80, 100, or 150 °F, to an upper limit of any one of 200, 250, 270, 290 or 300 °F, where any lower limit may be mathematically paired with any upper limit.

The method for the in-situ consolidation of sand may also include adding a gelation activator that further increases the strength of the resulting silica hydrogel, with the introduction of the sodium metasilicate and the additive. The gelation activator and the sodium metasilicate and additive, may be added separately or simultaneously to the wellbore. The sodium metasilicate and gelation activator mixture can be simultaneously injected into subterranean formation followed by supercritical carbon dioxide injection to form the permeable pathways.

In keeping with FIG. 1, the method 100 may include 104 injecting supercritical carbon dioxide into the subterranean formation thereby forming a silica hydrogel and consolidating sand grains with the silica hydrogel. Once carbon dioxide enters the formation, the reaction starts by forming silica hydrogel between the sand grains The formation of the silica hydrogel thereby consolidates the sand grains in the subterranean formation while maintaining permeability due to the nano-porous microstructure of the silica gel generated after the flow of supercritical carbon dioxide. While not wishing to be bound by a particular theory, it is believed that the injection of the carbon dioxide gas hardens the sodium metasilicate by two mechanisms. The first mechanism, according to Equation (1), includes an exothermic reaction between the carbon dioxide and the sodium metasilicate, which forms a silica gel bond. Another mechanism includes physical dehydration of the sodium metasilicate due to higher gas rate of carbon dioxide which causes production of adhesive sodium metasilicate bonds and the production of silica gel.

Na₂SiO₃+H₂O +CO₂—→Na₂CO₃+SiO₂+H₂O (1)

The reaction between the sodium metasilicate and the supercritical CO₂ occurs rapidly and maintaining the combination for extended periods could result in completely plugging the formation. The goal is to flow the supercritical CO₂ in the matrix in such a way that it creates a pathway. To eliminate the plugging potential, a follow-up pumping of an inert gas may be conducted. For example, nitrogen can be pumped following the supercritical CO₂ to displace the CO₂ and maintain the pathways created. The plugging of the formation may also be monitored via pressure buildup at the surface of the formation throughout the duration of the method. According to one or more embodiments, the composition of sodium metasilicate, sand and supercritical CO₂ may also be reacted/soaked for a time period ranging from 2-3 hours at a temperature of 200 °F. However, the time required to prevent plugging may vary depending on the reservoir temperature since the reaction is affected by reactant concentration and temperature.

In the embodiments described herein, the supercritical carbon dioxide may be injected at a temperature and pressure suitable to form supercritical dioxide. For instance, according to a pressure versus temperature curve, the supercritical dioxide may be formed at about room temperature (60-95 °F) and at about 1000 psi (950-1050 psi). However, the injection pressure and temperature may be adjusted depending on the pressure and/or temperature of the formation. The supercritical carbon dioxide may be introduced to the formation through bullheading procedures or injected with the use of coiled tubing.

As described above, the embodiments disclosed herein include sodium metasilicate. The amount of the sodium metasilicate added to the formation may rely on several factors. The amount added to the formation may vary with the volume of sand that needs to be consolidated. The amount may be determined from the volume, such as cylindrical volume around the wellbore. The amount of sodium silicate required to form enough silica hydrogel to consolidate an amount of unconsolidated sand may also depend on the type of sand and the amount of cementing materials present between sand grains.

Sodium metasilicate (Na₂SiO₂) is a metastable compound that easily decomposes to silicic acids, such as monosilisic acid, where it polymerizes to high molecular weight polymers. The high molecular weight polymers, due to the ability of adhering to sand grains, thereby form multiple physical strong bonds to the sand grains. The addition of the supercritical CO₂ to the water with the sodium metasilicate creates an acidic environment that promotes the decomposition to the silicic acids.

According to one or more embodiments, the sodium metasilicate may be in the form of an aqueous solution. The sodium metasilicate solution may have a concentration ranging from 1 to 40 wt % of sodium metasilicate based on the total weight of the solution, such as from a lower limit of any one of 1, 5, 10, 15 or 20 wt % to an upper limit of any one of 25, 30, 35 or 40 wt %, where any lower limit may be mathematically paired with any upper limit. In a preferred embodiment, the sodium metasilicate used may be a 25 wt % sodium metasilicate solution. The solution may include water. The sodium metasilicate solutions used in the methods described herein may be a neutral sodium metasilicate solution

The methods described herein may also include an additive. In high-temperature applications, the sodium silicate is highly stable. Thus, when operating temperatures exceed the formation temperature of 300 °F, additives may be used to prevent degradation of the material properties and to ensure optimal performance of the silica gel. The additives may be fillers and/or particles that can enhance the bonds between the grains. According to one or more embodiments, the additive may be selected from the group consisting of Aluminum Oxide, Calcium Oxide, Calcium Fluoride, Carbon Black, Graphite, Graphene, Amino Silane, Fire Clay, Iron Oxide, Magnesium Oxide, Magnesium Carbonate, Calcium Carbonate, Corn Flour, Corn Syrup, Dextrine, Sea Coal, Pitch, Carbohydrate, Dextrose, Nanoclay, Zirconia, and combinations thereof. The amount of additive added to the formation may be an amount such that the concentration of the additive is 1 to 2 wt % to bond the sand grains and to maintain pathways for production rather than completely plugging them.

As mentioned above, the method may also include the addition of a gelation activator. Examples of the gelation activator may include but are not limited to colloidal silica, inorganic salts, boric acid and combinations thereof. Suitable inorganic salts include but are not limited to NaCl, KCI, NH₄Cl, etc .. Further, the gelation activator may be added in an amount to affect a noticeable interaction. The gelation activator may be present in an amount of greater than 0.5, 1.0, 1.5, 5.0, 10, 15 or 20 wt % based on the amount of the sodium metasilicate and may reach an upper limit of 70, 75, 80 or 85 wt % based on the amount of the sodium metasilicate, where any lower limit may be mathematically paired with any upper limit.

Embodiments disclosed herein also relate to a sand consolidation composition that comprises a consolidated sand formation and the above described silica hydrogel formed by the above described method. The methods described herein provide a consolidated sand composition that is more productive than unconsolidated sand by demonstrating improved porosity and permeability that allows the flow of fluid through the pores of the structure. The consolidated sand product is a solid (hard, rigid), polymer-like or cross-linked foam having three phases: a hydrocarbon phase (from the hydrocarbon mixture), a water phase, and a gas phase (gas within the foam bubbles). Produced oil and gas may flow through the productive consolidated sand.

In one or more embodiments, the productive consolidated sand may have a porosity in a range of from 3 to 30%. For example, the productive consolidated sand may have a porosity in a range having a lower limit selected from any of 3%, 4%, and 5%, and an upper limit selected from any of 20%, 25%, and 30%, where any lower limit may be paired with any upper limit. The formation of the consolidated sand creates stable pathways for hydrocarbon flow during the production process.

In one or more embodiments, the productive consolidated sand may have a permeability in a range of from 10 to 600 milliDarcy (mD). For example, the consolidated sand may have a permeability in a range having a lower limit selected from any of 10, 20, 30, 40, and 50 mD, and an upper limit selected from any of 400, 450, 500, 550, and 600 mD, where any lower limit may be paired with any upper limit.

### EXAMPLES

### Example 1

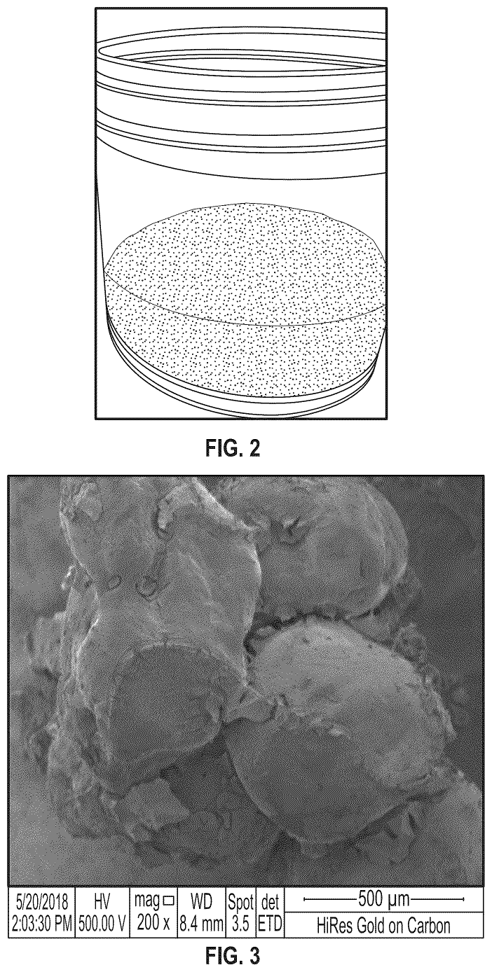

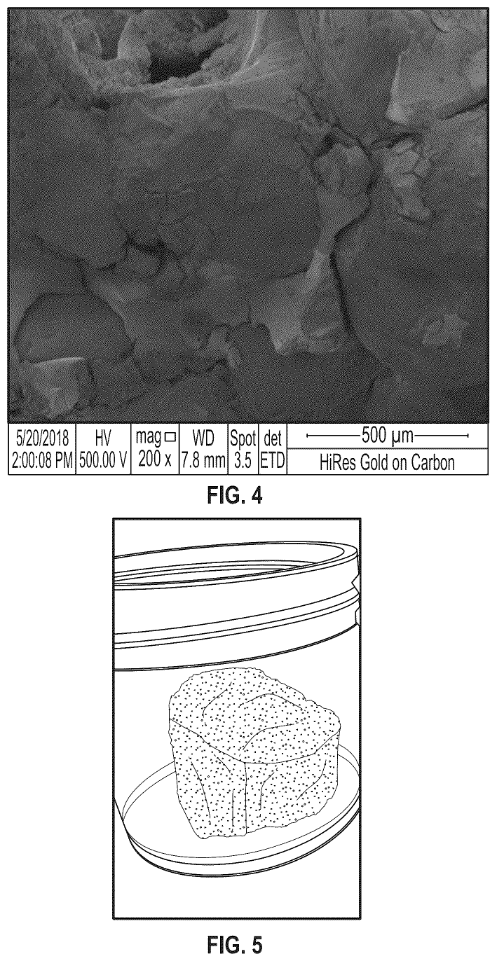

A sample of 25 wt. % sodium metasilicate stock solution was acquired from Adwan chemical industries (CAS No. 1344-09-8). A mixture of 20 wt. % of the sodium metasilicate stock solution and 80% unconsolidated silica sand, as shown in FIG. 2, was prepared at room temperature (77 °F). No additive was added to the mixture. The mixture was then transferred to a cylindrical accumulator connected to 100DX syringe pump. Supercritical carbon dioxide gas was flowed into the accumulator at ~1,100 psi at room temperature. The accumulator was disconnected and set inside an oven at ~200 °F for 3 hours. The sample was removed from the accumulator and analyzed with an Environmental Scanning Electron Microscope (ESEM). ESEM analysis, as shown in FIGS. 3-4, two different locations of the sample confirmed the consolidation of sand grains. Furthermore, FIG. 5 depicts an image of the resulting hardened consolidated sand sample.

### Comparative Example 1

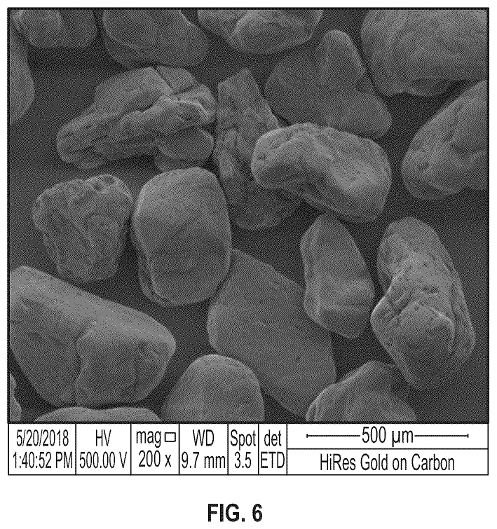

The procedure of Example 1 was repeated without the introduction of supercritical carbon dioxide. A 20 wt % sodium metasilicate to 80% silica sand sample was aged at 200 °F for 3 hours. The sample at the end of the test was wet but did not exhibit the same consolidation characteristics. ESEM analysis, as shown in FIG. 6, indicated that the sand grains were not consolidated when supercritical carbon dioxide was not used in combination with the sodium metasilicate.

Embodiments of the present disclosure may provide at least one of the following advantages. Unconsolidated sand formations with weak bonds between sand grains can be bound to result in more stable and permeable formations that will not induce sand production. The method disclosed herein thus forms a hydrogel that binds the sand grains without lowering the permeability of the formation.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

While one or more embodiments of the present disclosure have been described with respect to a limited number of embodiments, those skilled in the art, having benefit of this disclosure, will appreciate that other embodiments can be devised, which do not depart from the scope of the disclosure. Accordingly, the scope of the disclosure should be limited only by the attached claims.

1. A method for in-situ sand consolidation, the method comprising:
introducing sodium metasilicate into a subterranean formation within a wellbore; and
injecting supercritical carbon dioxide into the subterranean formation thereby forming a silica hydrogel and consolidating sand grains with the silica hydrogel to form a sand consolidation composition comprising a permeable consolidated sand formation and the silica hydrogel,
wherein a temperature of the subterranean formation ranges from 70 to 300 °F.

2. The method of claim 1, further comprising introducing an additive into the formation within the wellbore, wherein the additive is selected from the group consisting of aluminum oxide, calcium oxide, calcium fluoride, carbon black, graphite, graphene, amino silane, fire clay, iron oxide, magnesium oxide, magnesium carbonate, calcium carbonate, corn flour, corn syrup, dextrine, sea coal, pitch, carbohydrates, dextrose, nanoclay, zirconia, and combinations thereof.

3. The method of claim 2, wherein the sodium metasilicate and the additive are introduced separately.

4. The method of claim 2, wherein the sodium metasilicate and the additive are mixed prior to introduction into the subterranean formation.

5. The method of claim 2, further comprising:
adding a gelation activator that further increases a strength of the silica hydrogel,
wherein the gelation activator is selected from the group consisting of colloidal silica. inorganic salts, boric acid and combinations thereof.

6. The method of claim 1, wherein the subterranean formation is an unconsolidated sandstone formation.

7. The method of claim 1, wherein the sodium metasilicate is in the form of an aqueous solution.

8. The method of claim 7, wherein the sodium metasilicate is present in a concentration ranging from 1 to 40 wt %.

9. (canceled)

10. The method of claim 9, wherein the gelation activator is in an amount greater than 0.5 wt % based on the amount of the sodium metasilicate.

11. The method of claim 1, wherein the supercritical carbon dioxide is injected at a pressure ranging from 950 to 1050 psi.

12. The method of claim 1, wherein the supercritical carbon dioxide is injected at a temperature ranging from 60 to 95 ° F.

13. The method of claim 1, further comprising, after injecting supercritical CO₂, pumping nitrogen into the formation to displace the CO₂.

14. A sand consolidation composition comprising:
a consolidated sand formation; and
a silica hydrogel,
wherein the silica hydrogel is formed by:
introducing sodium metasilicate into an unconsolidated sand formation within a wellbore; and
injecting supercritical carbon dioxide into the unconsolidated sand formation to react with the sodium metasilicate and form the silica hydrogel,
wherein a temperature of the unconsolidated sand formation ranges from 70 to 300 °F.

15. The sand consolidation composition of claim 14, wherein the silica hydrogel comprises a silicate.

16. The sand consolidation composition of claim 14, wherein the consolidated sand formation comprises consolidated sand having a permeability in a range of from 10 to 600 mD.

17. The sand consolidation composition of claim 14, wherein the consolidated sand formation comprises consolidated sand having a porosity in a range of from 3 to 30%.

18. The sand consolidation composition of claim 14, wherein the introducing further comprises introducing an additive into the formation within the wellbore, wherein the additive is selected from the group consisting of aluminum oxide, calcium oxide, calcium fluoride, carbon black, graphite, graphene, amino silane, fire clay, iron oxide, magnesium oxide, magnesium carbonate, calcium carbonate, corn flour, corn syrup, dextrine, sea coal, pitch, carbohydrates, dextrose, nanoclay, zirconia, and combinations thereof.

19. The sand consolidation composition of claim 14, wherein the introducing further comprises adding a gelation activator that further increases a strength of the silica hydrogel, wherein the gelation activator is selected from the group consisting of colloidal silica, inorganic salts, boric acid and combinations thereof.

20. The sand consolidation composition of claim 14, wherein the sodium metasilicate is present in a concentration ranging from 1 to 40 wt %.

21. The sand consolidation composition of claim 14, wherein the consolidated sand formation is a permeable consolidated sand formation.
